(19) United States
(12) Patent Application Publication
(10) Pub. No.: US 2009/0258208 A1
(43) Pub. Date: Oct. 15, 2009

(54) Compositions And Composite Articles Suitable For High Heat Applications

(76) Inventors: Brad J. Martin, Dearborn, MI (US); Lisa H. Perricane, Grosse Ile, MI (US); Michael L. Jackson, Grosse Ile, MI (US); Michael J. Haspel, Grosse Ile, MI (US)

Correspondence Address: HOWARD & HOWARD ATTORNEYS PLLC;BASF SE, 450 West Fourth Street, Royal Oak, MI, 48067, US

(21) Appl. No.: 12/100,912

(22) Filed: Apr. 10, 2008

(51) Int. Cl. B32B 27/08; B32B 5/00

(52) U.S. Cl. 428/220; 525/238; 524/522; 428/421; 428/335

(57) ABSTRACT

A composition comprising a first polymeric component comprising chlorinated polyvinyl chloride (CPVC); a second polymeric component comprising at least one of (i) a mixture of styrene acrylonitrile (SAN) and an impact modifier, and (ii) a reaction product of the mixture; and a third polymeric component comprising alpha-methylstyrene acrylonitrile (AMSAN). The second and third polymeric components are present in a combined amount of at least about 7 parts by weight based on 100 parts by weight of the composition. The composition has a heat distortion temperature greater than about 180° F. according to ASTM D 648. A composite article comprises a capstock layer comprising a weatherable thermoplastic and a substrate layer comprising the composition.

### FIELD OF THE INVENTION

The present invention generally relates to a composition, and more specifically, to a composition comprising a first polymeric component comprising chlorinated polyvinyl chloride (CPVC); a second polymeric component comprising at least one of (i) a mixture of styrene acrylonitrile (SAN) and an impact modifier, and (ii) a reaction product of the mixture; and a third polymeric component comprising alpha-methylstyrene acrylonitrile (AMSAN); and to a composite article comprising a substrate layer comprising the composition.

### DESCRIPTION OF THE RELATED ART

Polymeric compositions are well known to those skilled in the polymer art. Various polymeric compositions have been developed over the years for various applications. For example, blends of acrylonitrile butadiene styrene (ABS) and polyvinyl chloride (PVC) have been used for making siding for houses and other similar structures. Other polymeric compositions have also been developed that include chlorinated polyvinyl chloride (CPVC) as a primary component, because CPVC is useful for imparting the polymeric compositions with high heat properties, such as improved dimensional stability above 160° F . Polymeric compositions comprising high levels of CPVC, e.g. 95+wt % of CPVC, to obtain high heat properties have higher densities because of the density of CPVC (˜1.6 g/cm³) compared to the density of PVC (˜1.4 g/cm³). However, CPVC is more expensive than PVC and other polymers. In addition, it is more difficult to process the aforementioned polymeric composition comprising high levels of CPVC due to thermal decomposition issues, such as formation of hydrochloric acid, which leads to increased cost of manufacture.

Articles formed from the aforementioned polymeric compositions, such as PVC house siding, are generally only available in light colors such as white and pastels, e.g. autumn yellow. Darker colored articles, such as black, red, dark brown, etc., absorb more heat from the sun compared to lighter colors, which leads to distortion of the darker colored articles such as dark colored PVC house siding. Over time, prolonged absorption of heat can lead to softening and permanent distortion of the articles, such as sagging, buckling and warping of the articles. For example, PVC house siding can be used in cooler climates in light colors, e.g. white or pastels, but can not be used in hot climates in dark colors, such as green, brown, or blue colors, in southern and southwestern U.S. climates. This is mainly due to PVC having a low heat deflection temperature of 160° F., where higher temperatures cause PVC to soften and distort as like described above. Many of the aforementioned articles also have weatherability problems because they fade and discolor over time when exposed to the elements. As such, some of these articles have been made into composite articles to alleviate several of these weatherability problems, for example, by capping a layer formed from PVC with a layer formed from acrylonitrile styrene acrylate (ASA). However, expansion and contraction of these composite articles, when exposed to increasing and decreasing temperatures, respectively, can still cause problems.

Accordingly, there remains an opportunity to provide improved compositions and composite articles made from the improved compositions.

### SUMMARY OF THE INVENTION AND ADVANTAGES

The present invention provides a composition. The composition comprises a first polymeric component comprising chlorinated polyvinyl chloride (CPVC); a second polymeric component comprising at least one of (i) a mixture of styrene acrylonitrile (SAN) and an impact modifier, and (ii) a reaction product of the mixture; and a third polymeric component comprising alpha-methylstyrene acrylonitrile (AMSAN). The second and third polymeric components are present in a combined amount of at least about 7 parts by weight based on 100 parts by weight of the composition. The composition has a heat distortion temperature greater than about 180° F. according to ASTM D 648. The present invention further provides a composite article comprising a capstock layer comprising a weatherable thermoplastic and a substrate layer comprising the composition.

The composition provides a unique combination of the first, second, and third polymeric components. The polymeric components impart the composition with improved processability and flame retardancy. In addition, the polymeric components impart the composition and composite article with improved weatherability and increased heat distortion temperatures.

### DETAILED DESCRIPTION OF THE INVENTION

The present invention provides a composition. The composition comprises a first polymeric component, a second polymeric component, and a third polymeric component. The present invention further provides a composite article comprising a substrate layer comprising the composition, which is further described below.

The first polymeric component comprises chlorinated polyvinyl chloride (CPVC). As known to those of ordinary skill in the polymer art, CPVC is typically classified as a polymer, which is made by chlorination of a polyvinyl chloride (PVC) polymer. For example, CPVC can be made by chlorination of suspension or mass polymerized PVC. It is to be appreciated that the present invention is not limited to any particular method of making the CPVC.

By definition, CPVC polymers have greater chlorine contents, by percent weight, than PVC polymers, which generally have a chlorine content of about 56.7 percent by weight based on the total weight of the PVC polymer. For purposes of the present invention, the CPVC typically has a chlorine content of from about 57 to about 74, more typically from about 60 to about 70, and most typically from about 63 to about 70, percent by weight, based on the total weight of the CPVC. It is to be appreciated that two or more different types or grades of CPVC may be used for making the composition, such as two different grades of CPVC with different chlorine contents. Without being bound or limited to any particular theory, it is believed that increasing the chlorine content of the CPVC imparts the CPVC with increased physical properties relative to lower chlorine contents, e.g. PVC, such as an increased glass transition temperature (T_{g}) and increased flame retardancy.

The first polymeric component is typically present in the composition in an amount of from about 30 to about 93, more typically from about 40 to about 90, yet more typically from about 50 to about 80, and most typically from about 60 to about 70, parts by weight, based on 100 parts by weight of the composition. In one embodiment, the first polymeric component is present in an amount less than about 50 parts by weight based on 100 parts by weight of the composition. It is believed that this embodiment is useful for increasing processability of the composition. Without being bound or limited to any particular theory, it is believed that decreasing the amount of the first polymeric component present in the composition increases processability of the composition. It is also believed that the first polymeric component imparts the composition with excellent physical properties such as dimensional stability and flame retardancy, as described in further detail below. Specific examples of suitable grades of CPVC, for purposes of the present invention, are commercially available from Lubrizol Corporation, of Wickliffe, Ohio, under the trademark of TEMPRITE®, such as TEMPRITE® CPVC.

The first polymeric component may be of various forms prior to forming the composition, such as a powder, pellets, strands, beads, a solid, a semi-solid, a liquid (depending on, for example, temperature), etc. Typically, the first polymeric component is in the form of a bead or beads prior to forming the composition, which may be of various sizes and shapes; however, it is to be appreciated that the first polymeric component may be in other forms known to those skilled in the polymeric art besides those forms described and exemplified above.

The second polymeric component comprises at least one of (i) a mixture of styrene acrylonitrile (SAN) and an impact modifier, and (ii) a reaction product of the mixture. In other words, the second polymeric component may comprise either the mixture of SAN and the impact modifier by itself, the reaction product of the mixture by itself, or both the mixture and the reaction product of the mixture.

In certain embodiments, the second polymeric component comprises the mixture of SAN and the impact modifier. SAN is typically classified as a copolymer, which is made by reacting acrylonitrile monomers and styrene monomers. The SAN typically has an acrylonitrile content of from about 15 to about 45, more typically from about 20 to about 40, and most typically from about 25 to about 35, parts by weight, based on 100 parts by weight of the SAN. Further, the SAN typically has a styrene content of from about 55 to about 85, more typically from about 60 to about 80, and most typically from about 65 to about 75, parts by weight, based on 100 parts by weight of the SAN. In one embodiment, the SAN has an acrylonitrile content of from about 30 to about 35, and a styrene content of from about 65 to about 70, parts by weight, both based on 100 parts by weight of the SAN. Specific examples of suitable grades of SAN, for purposes of the present invention, are commercially available from BASF Corporation of Florham Park, N.J., under the trademark of LURAN®, such as LURAN® 358N and LURAN® 368R. It is to be appreciated that two or more different types or grades of SAN may be used for making the composition, such as two different grades of SAN with different styrene contents.

The impact modifier may be any impact modifier known in the art. Suitable impact modifiers, for purposes of the present invention include, but are not limited to, acrylate rubbers, butyl-acrylate rubbers, ethylene-propylene-diene (EPDM) rubbers, methacrylate butadiene styrenes (MBS), chlorinated polyethylenes, and combinations thereof. It is to be appreciated that the composition may include a combination of two of more of the aforementioned impact modifiers. Specific examples of suitable impact modifiers, e.g. acrylic impact modifiers, for purposes of the present invention, are commercially available from Rohm and Hass Chemicals LLC of Philadelphia, Pa. under the trademark of PARALOID™, such as PARALOID™ KM-334.

In certain embodiments, the second polymeric component comprises the reaction product of the mixture, i.e., the reaction product of the SAN and the impact modifier. It is to be appreciated that various reaction products may be made, depending on the types of SAN and impact modifiers employed, and the amounts thereof. Examples of suitable reaction products, for purposes of the present invention, include, but are not limited to, SAN-soluble polybutadiene rubber, SAN-soluble polybutyl acrylate rubber, SAN-soluble EPDM rubber, and combinations thereof. It is to be appreciated that the reaction product may comprise two or more different types of grades of SAN, and/or two or more different types or grades of impact modifier. It is also to be appreciated that the composition may include free SAN and free impact modifier alternatively, or in addition to, the reaction product, as alluded to above.

If employed, either in free form or as part of the reaction product, the SAN and impact modifier are typically in a weight ratio of SAN to impact modifier (SAN:impact modifier) of from about 15:35 to about 35:65, more typically from about 60:40 to about 40:60, and most typically from about 55:45 to about 45:55.

In certain embodiments, the reaction product comprises at least one of acrylonitrile styrene acrylate (ASA) and acrylonitrile butadiene styrene (ABS). In one embodiment, the second polymeric component comprises ASA. In another embodiment, the second polymeric component comprises ABS. In yet another embodiment, the second polymeric component comprises a blend of ASA and ABS. In the aforementioned embodiment, the ASA and the ABS can be mixed in any ratio by weight relative to one another. For example, the blend can include a majority of the ASA relative to the ABS or vice versa. As another example, the blend can also include the ASA and ABS in about equal amounts, such as in about a 50:50 ratio by weight relative to one another.

ASA and ABS are both typically classified as terpolymers, which can be made by various methods known to those skilled in the polymer art. For example, ASA can be made by grafting SAN, i.e., the SAN as described and exemplified below, onto the impact modifier, more specifically, polybutyl acrylate rubber, to form SAN-soluble polybutyl acrylate rubber. The SAN-soluble polybutyl acrylate rubber and additional SAN are then compounded to form the ASA. ABS can be made in a similar method as described above for the ASA, except that polybutyl diene rubber is used as the impact modifier in place of the polybutyl acrylate rubber. An apparatus known in the polymer art, such as an extruder, can be used for compounding. It is to be appreciated that the present invention is not limited to any particular method of making the ASA and ABS. It is also to be appreciated that the composition may include other reaction products in addition to or alternative to the ASA and/or ABS, if employed.

If employed as or in the second polymeric component, the ASA typically has an acrylonitrile content of from about 10 to about 40, more typically from about 12 to about 30, and most typically from about 15 to about 25, parts by weight, based on 100 parts by weight of the ASA. Further, the ASA typically has a styrene content of from about 30 to about 70, more typically from about 40 to about 60, and most typically from about 45 to about 55, parts by weight, based on 100 parts by weight of the ASA. Yet further, the ASA typically an acrylate content of from about 10 to about 60, more typically from about 15 to about 50, and most typically from about 18 to about 40, parts by weight, based on 100 parts by weight of the ASA. In one embodiment, the ASA has an acrylonitrile content of from about 18 to about 25, a styrene content of from about 48 to about 53, and an acrylate content of from about 25 to about 30, parts by weight, all based on 100 parts by weight of the ASA. Specific examples of suitable grades of ASA, for purposes of the present invention, are commercially available from BASF Corporation, under the trademark of LURAN® S, such as LURAN® S 797 and LURAN® S 776. It is to be appreciated that two or more different types or grades of ASA may be used for making the composition, such as two different grades of ASA with different acrylate contents.

If employed as or in the second polymeric component, the ABS typically has an acrylonitrile content of from about 5 to about 40, more typically from about 8 to about 35, and most typically from about 10 to about 30, parts by weight, based on 100 parts by weight of the ABS. Further, the ABS typically has a styrene content of from about 40 to about 75, more typically from about 45 to about 70, and most typically from about 50 to about 65, parts by weight, based on 100 parts by weight of the ABS. Yet further, the ABS typically a butadiene content of from about 10 to about 60, more typically from about 15 to about 50, and most typically from about 20 to about 45, parts by weight, based on 100 parts by weight of the ABS. In one embodiment, the ABS has an acrylonitrile content of from about 13 to about 17, a styrene content of from about 53 to about 58, and a butadiene content of from about 25 to about 30, parts by weight, all based on 100 parts by weight of the ABS. Specific examples of suitable grades of ABS, for purposes of the present invention, are commercially available from BASF Corporation, under the trademark of TERLURAN®, including TERLURAN® HH (High Heat). It is to be appreciated that two or more different types or grades of ABS may be used for making the composition, such as two different grades of ABS with different butadiene contents.

The second polymeric component, e.g. ASA and/or ABS, is typically present in the composition in an amount of from about 2 to about 30, more typically from about 5 to about 25, and most typically from about 10 to about 20, parts by weight, based on 100 parts by weight of the composition. Without being bound or limited to any particular theory, it is believed that the second polymeric component imparts the composition with increased physical properties such as increased resistance to discoloration and degradation from UV light, atmospheric oxygen, and heat from processing, especially when ASA is employed. It is also believed that the second polymeric component can impart the composition with increased impact resistance, especially when ABS is employed. If employed, impact modifiers based on EPDM rubber provide good low temperature impact resistance.

The second polymeric component may be of various forms prior to forming the composition, such as a powder, pellets, strands, beads, a solid, a semi-solid, a liquid (depending on, for example, temperature), etc. Typically, the second polymeric component is in the form of a bead or beads prior to forming the composition, which may be of various sizes and shapes; however, it is to be appreciated that the second polymeric component may be in other forms known to those skilled in the polymeric art besides those forms described and exemplified above. It is also to be appreciated that if the second polymeric component comprises SAN and the impact modifier, the SAN and the impact modifier may each be in the same form or a different form from each other, such as beads and beads, beads and powder, etc.

The third polymeric component comprises alpha-methylstyrene acrylonitrile (AMSAN). As known to those of ordinary skill in the polymer art, AMSAN is typically classified as a copolymer. However, for purposes of the present invention, the AMSAN may include AMSAN copolymers, AMSAN terpolymers, i.e., alpha-methylstryrene/stryrene/acrylonitrile, or combinations thereof. In one embodiment, the AMSAN consists of AMSAN copolymer. In another embodiment, the AMSAN consists essentially of AMSAN copolymer, i.e., the AMSAN comprises some amount of AMSAN terpolymer in addition to AMSAN copolymer. AMSAN can be made by various methods known to those skilled in the polymer art. AMSAN is typically made by reacting alpha-methyl styrene monomers and acrylonitrile monomers.

The AMSAN typically has an acrylonitrile content of from about 15 to about 45, more typically from about 20 to about 40, and most typically from about 25 to about 35, parts by weight, based on 100 parts by weight of the AMSAN. Further, the AMSAN typically has an alpha-methylstyrene content of from about 55 to about 85, more typically from about 60 to about 80, and most typically from about 65 to about 75, parts by weight, based on 100 parts by weight of the AMSAN. In one embodiment, the AMSAN has an acrylonitrile content of from about 29 to about 34, and an alpha-methylstyrene content of from about 66 to about 71, parts by weight, both based on 100 parts by weight of the AMSAN. Specific examples of suitable grades of AMSAN, for purposes of the present invention, are commercially available from BASF Corporation, under the trademark of LURAN®, such as LURAN® KR2556, and including LURAN® HH, such as LURAN HH-120. It is to be appreciated that two or more different types or grades of AMSAN may be used for making the composition, such as two different grades of AMSAN with different acrylonitrile contents.

The third polymeric component is typically present in the composition in an amount of from about 5 to about 45, more typically from about 10 to about 40, and most typically from about 15 to about 30, parts by weight, based on 100 parts by weight of the composition. Without being bound or limited to any particular theory, it is believed that the third polymeric component imparts the composition with increased physical properties such as increased heat resistance, such as an increased HDT and storage modulus.

The third polymeric component may be of various forms prior to forming the composition, such as a powder, pellets, strands, beads, a solid, a semi-solid, a liquid (depending on, for example, temperature), etc. Typically, the third polymeric component is in the form of a bead or beads prior to forming the composition, which may be of various sizes and shapes; however, it is to be appreciated that the third polymeric component may be in other forms known to those skilled in the polymeric art besides those forms described and exemplified above.

The second and third polymeric components are present in the composition in a combined amount of at least about 7 parts by weight, alternatively at least about 10 parts by weight, alternatively at least about 15 parts by weight, alternatively as least about 25 parts by weight, all based on 100 parts by weight of the composition. Without being bound or limited to any particular theory, it is believed that the aforementioned embodiments are useful for increasing processability of the composition. In one embodiment, the first polymeric component is present in the composition in an amount of from about 30 to about 93, the second polymeric component is present in the composition in an amount of from about 2 to about 30, and the third polymeric component is present in the composition in an amount of from about 5 to about 45, parts by weight, all based on 100 parts by weight of the composition.

It is to be appreciated that the monomers employed to make the respective copolymers and terpolymers of the first, second, and third polymeric components may be of any configuration known in the polymer art after polymerization, such as block, heteric/random, alternating, and or graft configurations, depending on, for example, the specific monomers and amounts thereof, polymerization reaction conditions, and monomer order of addition.

In certain embodiments, the composition further comprises a colorant component in addition to the first, second, and third polymeric components. The colorant component is typically a pigment or a pigment blend of two or more pigments; however, other colorants may also be used. The pigment, or pigment blend, is used to impart a desired color to the composition. Different types of pigments can be used. For example, titanium dioxide can be used to impart a white color and carbon black can be used to impart a black color, to the composition, respectively, while various blends of titanium dioxide and carbon black can be used to impart various shades of gray to the composition. Examples of suitable grades of carbon black and titanium dioxide, for purposes of the present invention, are commercially available from Columbian Chemicals Company of Marietta, Ga., and DuPont® Titanium Technologies of Wilmington, Del., respectively.

Other pigments including, but not limited to, red, green, blue, yellow, green, and brown, and pigment blends thereof, can also be used to impart color to the composition in addition to or alternative to carbon black and/or titanium dioxide. Examples of suitable grades of pigments, for purposes of the present invention, are commercially available from various companies such as BASF Corporation of Florham Park, N.J. It is to be appreciated that various blends of the aforementioned colorant components, e.g. pigments, can be used to impart the composition with various colors, strengths, and shades. The color component can be in various forms, such as dry powders, liquid dispersions, masterbatches, and/or concentrates prior to making the composition.

If employed in the composition, the colorant component is typically present in the composition in an amount suitable to impart the composition with a desired color, strength and shade, more typically in an amount not materially affecting physical properties of the composition. In certain embodiments employing the colorant component, the colorant component is typically present in the composition in an amount of from about 4 to about 20, more typically from about 5 to about 15, and most typically from about 6 to about 8, parts by weight, based on 100 parts by weight of the composition. If employed in the composition, the colorant component can be included with one or more of the polymeric components, or as a distinct component.

Whether or not the colorant component is employed in the composition, the composition has a color defined by an L* value, an a* value, and a b* value, i.e., the composition has L*a*b* values. L*a*b* values of the composition can be measured by a spectrophotometer according to a Hunter Lab color scale. The Hunter Lab color scale is a color-measuring system that is well known to those skilled in the color art. The spectrophotometer employed for measuring the L*a*b* values is typically a 45°/0° spectrophotometer, such as those commercially available from X-Rite Incorporated of Grand Rapids, Mich., although other types of spectrophotometers can also be used. In the Hunter Lab color scale, the L* value is associated with a central vertical axis that represents lightness and darkness, the lightest being L*=100 (white) and the darkest being L*=0 (black). Further, in the Hunter Lab color scale, the a* value is associated with a red/green scale and the b* scale is associated with a yellow/blue scale. It is to be appreciated that unlike the L* value, the a* and b* values have no numerical limits. A positive a* value is red and a negative a* value is green. A positive b* value is yellow and a negative b* value is blue. It is to be appreciated that other color scales can be used to determine the color of the composition, such as CIELAB color space.

When the colorant component is employed to make the composition, the composition can have a light color, a medium color, or a dark color. For example, the composition can range from white or yellow in color, to light blue or light gray in color, to dark brown or dark green in color. By “light” color, it is meant that the composition has an L* value of from 100 to about 75. By “medium” color, it is meant that the composition has an L* value of from about 75 to about 60. By “dark” color, it is meant that the composition has an L* value of from about 60 to 0. In one embodiment, the composition has an L* value less than about 60. In another embodiment, the composition has an L* value less than about 50. In yet another embodiment, the composition has an L* value less than about 40. In yet another embodiment, the composition has an L* value less than about 30. The composition is especially useful for applications requiring medium and dark colors, which is described in further detail below.

The composition may further comprise an additive component in addition to the first, second and third polymeric components. The additive component may be selected from the group of, but is not limited to, colorants (such as those described and exemplified above), plasticizers, lubricants, UV stabilizers, thermal stabilizers, antioxidants, antistatic agents, flame retardants, fillers, fibers, processing aids, and combinations thereof. In certain embodiments employing the additive component, the additive component is typically present in the composition in an amount of from about 1 to about 40, more typically from about 2 to about 30, and most typically from about 5 to about 25, parts by weight, based on 100 parts by weight of the composition. If employed in the composition, the additive component can be included with one or more of the polymeric components, or as a distinct component.

In one embodiment, the composition consists essentially of the first, second, and third polymeric components. In other embodiments, in addition to or alternate to the previously described embodiment, the substrate layer consists essentially of the composition. By “consisting essentially of”, it is meant that, if present in the composition and therefore the substrate layer, additional components other than the first, second, and third polymeric components, e.g. the colorant component and/or the additive component, do not materially affect the composition or the substrate layer, such as physical properties including heat distortion temperature (HDT), which is described in further detail below.

The composition may be of various forms, such as powder, pellets, strands, beads, a solid, a semi-solid, a liquid (depending on, for example, temperature), etc. Typically, the composition is in the form of a strand, a bead, strands, beads, or a sheet, which may be of various sizes and shapes, more typically in the form of pellets, powder, a sheet, or a finished article. It is to be appreciated that the composition may be in other forms known to those skilled in the polymeric art besides those forms described and exemplified above.

The composition is generally prepared by compounding together the first, second, and third polymeric components, and optionally, the colorant component and/or the additive component, in an apparatus. For example, beads of CPVC, beads of ASA, and beads of AMSAN, can be introduced to and compounded in the apparatus to form beads, strands, sheets, etc. of the composition. The apparatus should be able to apply both heat and shear to the components to make the composition. Examples of suitable apparatuses for compounding the components to make the composition include: Banbury mills and two-roll mills; LIST compounding rotating processors; Farrell continuous mixers; and more typically ring-, twin-, and single-screw and planetary extruders.

After compounding, the composition can be formed into an end article, such as a sheet or film, or the composition can be pelletized, such as by extruding, water bathing, and sheeting, slitting, or cutting the composition into pellets or cubes. Typical apparatuses for making the composition are extruders, such as those described and exemplified above, where the components can be batch or continuously fed and compounded to make the composition, and the composition can then be pelletized for later use or formed directly into an end article, such as a substrate, which is described further below. The composition is generally classified as a thermoplastic material, and therefore can be processed and formed into final articles as such. For example, the composition can be molded, thermoformed, or extruded into an article, such as a sheet as described above.

The composition and the composite article are especially suitable for high heat applications, such as for plumbing, e.g. for hot water piping, and for construction components, e.g. for siding and roofing. The composition and the composite article have excellent dimensional stability. The composite article is described in further detail below. Specifically, as alluded to above, the composition has a heat distortion temperature (HDT) greater than about 180° F. according to ASTM D 648. In certain embodiments, the composition has a HDT greater than about 200° F., and in other embodiments, the composition has a HDT greater than about 210° F. As described above, without being bound or limited to any particular theory, it is believed that HDT of the composition can be varied by chlorine content in the first polymeric component. It is also believed that the HDT of the composition can be varied by the specific components and amounts thereof employed in the composition, such as specific types and amounts thereof of the polymeric components and/or the additive components employed to make the composition.

The composition also has other physical properties, which can be adjusted higher or lower much like adjusting the HDT of the composition. In certain embodiments, the composition typically has a melt volume rate of from about 1.5 to about 4.0 cm³/10 minutes at 190° C./21.6 kg according to ASTM D 1238. Those of ordinary skill in the polymer art appreciate that melt flow rate of the composition may be measured by a rate of extrusion of the composition through a die of a specified length and diameter under prescribed conditions of temperature, load, and piston position in a barrel as a timed measurement is made. The melt flow rate of the composition generally determines processing parameters for forming the composition into desired articles. In certain embodiments, the composition has a Vicat softening temperature of from about 104° C. to about 110° C. according to ISO 306, method B50. In other embodiments, the composition has an impact resistance of from about 10 to about 12 kJ/m² at room temperature according to ISO 179-1. In further embodiments, the composition has an elongation at break of from about 10% to about 20% according to ISO 527-2.

The composite article comprises a capstock layer and a substrate layer. The capstock layer comprises a weatherable thermoplastic. As described above, the substrate layer comprises, i.e., is formed from, the composition of the present invention. By “weatherable”, it is meant that the capstock layer is suitable for withstanding various exterior conditions, i.e., exposure to the elements, such as various degrees of sunlight, temperature, and moisture, without any appreciable degradation over time, such as over one or more years of exposure. It is to be appreciated that the substrate, and therefore, the composition, can also be weatherable in certain embodiments. In other words, the composition can be used in applications that demand weatherability without use of the capstock layer.

The weatherable thermoplastic of the capstock layer typically comprises at least one of an acrylic polymer, a fluoropolymer, an acrylonitrile styrene acrylate (ASA), PVC, a polyvinylidene fluoride (PVDF), poly(acrylonitrile ethylene styrene) (AES), and an aliphatic thermoplastic polyurethane (TPU). In other words, the capstock layer can comprise one of or two or more of the aforementioned materials. Examples of suitable acrylic polymers, for purposes of the present invention, include LUCITE® TUFCOAT® and SOLARKOTE®.

In one embodiment, the capstock layer comprises ASA, and in a further embodiment, consists essentially of ASA. ASA is durable, thermally stable, chemically resistant, and colorfast, which can make the composite article especially suitable for long-term outdoor use. If employed for the capstock layer, the ASA may be the same as or different from the ASA employed in the composition, such as if the ASA is employed in the substrate layer of the composite article. It is to be appreciated that the capstock layer may comprise a combination of two or more of the weatherable thermoplastics described and exemplified above. In addition, the capstock layer may comprise two or more layers of the weatherable thermoplastics. For example, the capstock layer can comprise a layer of fluoropolymer disposed over a layer of ASA or vice versa.

The capstock layer is typically bonded to the substrate layer, which can be accomplished by various methods. For example, the capstock layer can be bonded to the substrate layer with an adhesive, e.g. a polyurethane adhesive. More typically, the capstock and substrate layers are laminated or co-extruded to bond the capstock and substrate layers together. For example, a layer of ASA can be co-extruded with a layer of the composition, i.e., the substrate, to form the composite article. The composition may be made and directly formed into the substrate, rather than into beads, strands, etc. It is to be appreciated that the present invention is not limited to any particular method of making the composite article.

The composite article can be formed into various thicknesses depending on specific requirements or applications of the composite article. In certain embodiments, the layers have a combined thickness of at least about 22 mils. In other embodiments, the composite article has a thickness of from about 22 to about 170 mils. In one embodiment, the capstock layer has a thickness of at least about 2 mils and the substrate layer has a thickness of at least about 20 mils. In another embodiment, the capstock layer has a thickness of from about 2 to about 20 mils, and the substrate layer has a thickness of from about 20 to about 150 mils. In one embodiment, the composite article is configured as a siding article with the capstock layer having a thickness of about 4 mils and the substrate layer having a thickness of about 40 mils. In another embodiment, the composite article is configured as a roofing article with the capstock layer having a thickness of about 15 mils and the substrate layer having a thickness of about 90 mils. It is to be appreciated that the composite article can be configured with various combinations of thicknesses based on specific applications of the composite article.

At least one of the layers of the composite article may further comprise the colorant component, as described and exemplified above. If both the capstock and substrate layers include the colorant component, the colorant component of the substrate layer may be the same as or different from the colorant component of the capstock layer. For example, the substrate layer may include titanium dioxide, i.e., the substrate layer may be white in color, and the capstock layer may include a green pigment, i.e., the capstock layer may be green in color.

The composite articles can have any color, and are especially useful for medium and dark colors. However, it is to be appreciated that the composite article can have a light color, a medium color, or a dark color. For example, the composite article can range from white or yellow in color, to light blue or light gray in color, to dark brown or dark green in color. In one embodiment, the composition has an L value less than about 60. In another embodiment, the composite article has an L value less than about 50. In yet another embodiment, the composite article has an L value less than about 40. In yet another embodiment, the composite article has an L value less than about 30. For purposes of the present invention, color of the composite article is typically determined by measuring from the direction of the capstock layer down. The composite article can also have any gloss level based upon the specific capstock layer employed to make the composite article. In certain embodiments, the capstock layer has a texture, embossing, and/or grain pattern formed therein. For example, the capstock layer can have a grain pattern that simulates wood grain.

As least one of the one of the layers of the composite article may further comprise the additive component, as described and exemplified above, in addition to or alternative to the colorant component, if employed. If both layers include the additive component, the additive component of the substrate layer may be the same as or different from the additive component of the capstock layer. For example, the substrate layer may include a flame retardant and the capstock layer may include an impact modifier, such as the impact modifier described and exemplified above with description of the composition.

The composite articles of the present invention can be used for various applications, and are especially useful for exterior applications. For example, the composite articles can be used for, but are not limited to, plumbing, siding, fencing, window, and roofing applications. As further examples, the composite article can be formed into various housing articles, such as shingles, shakes, tiles, slates, boards, panels, and planks. These composite articles can be made by various methods known in the forming and molding art, such as by molding or extrusion; however, other methods may also be used. The composite article can be of various dimensions and sizes, and can define holes to facilitate attachment of the composite article to a structure, such as a house. However, it is to be appreciated that holes are not required to use the composite article in combination with the structure.

As briefly described above, the composite articles are especially suitable for high heat applications. Specifically, the substrate layer has a HDT greater than about 180° F. according to ASTM D 648. In certain embodiments, the substrate layer has a HDT greater than about 200° F., and in other embodiments, the substrate layer a HDT greater than about 210° F. The HDT of the substrate layer can be adjusted based on specific requirements or applications of the composite article. For example, composite articles having darker colors will generally need a higher HDT than those having lighter colors used in the same climate and application, due to heat absorption differences, such as house siding used in the Midwestern United States. Specific composite articles, such as siding and trim for siding applications will also generally need a higher HDT, since these composite articles are often subjected to reflective heat from windows, adjacent walls or adjacent structures. Similar to HDT, the composite articles can also be configured to have varying coefficients of linear thermal expansion (CLTEs) based upon the specific components and amounts thereof, width and length dimensions of the layers, and thicknesses of the layers employed to make the composite article.

In certain embodiments, the composite article can be configured to meet building code requirements, which are especially important if the composite article is used for construction applications, such as a component of an industrial, commercial or residential building. As such, in certain embodiments, the composite article at least meets one or more of the following tests: Class C flammability requirements according to UL 790; wind resistance, uplift bend and penetration requirements according to ICBO AC 07; flammability requirements according to ASTM E-84; flammability requirements according to FM4450.

The following examples, illustrating the compositions and composite articles of the present invention, are intended to illustrate and not to limit the invention.

### EXAMPLES

Two comparative composition examples are prepared, specifically Comparative 1 and 2. Comparative 1 is 100% of the first polymeric component, while Comparative 2 is a blend of the first and third polymeric components, which are compounded via extrusion. Seven inventive composition examples are also prepared, specifically Inventive 1 through 7. The seven inventive examples comprise a blend of the first, second (two types), and third polymeric components in varying amounts, which are compounded via extrusion. Various physical tests are performed on the examples. HDT of the examples is determined according to ASTM D 648. Vicat is determined according to ISO 306/b50. CLTE is determined according to ASTM D 696. Notched Izod, Charpy Impact, and Gardner Impact are determined according to ASTM D 256/A, ISO 179/1eA, and ASTM D 5420. Tensile Strength, Tensile Stress, and Tensile Modulus are determined according to ASTM D 638 and Flexural Modulus and Flex Strength are determined according to ASTM D 790/A. Elongation at Yield % and Elongation at Break % are determined according to ASTM D 638. Burn rate is determined according to UL94 HB. The amount and type of each component used to form the compositions are indicated in Tables I though IV below with all values in parts by weight based on 100 parts by weight of the composition unless otherwise indicated. The symbol “-” indicates that the component is absent from the formulation.

TABLE I

| | Composition Examples | | | |
|---|---|---|---|---|
| Components | Comparative 1 | Comparative 2 | Inventive 1 | Inventive 2 |
| First Polymeric Component | 100 | 50 | 50 | 50 |
| Second Polymeric Component 1 | — | — | 5 | 10 |
| Second Polymeric Component 2 | — | — | — | — |
| Third Polymeric Component | — | 50 | 45 | 40 |
| HDT, ° F. | 165.2 | 188.6 | 186.4 | 183.4 |
| Vicat, ° F. | 207.5 | 230.0 | 228.2 | 228.2 |
| CLTE (/° F. 10⁻⁶) | 34 | 32 | 33 | 35 |
| Notched Izod, ft-lb/in | 1.5 | 0.1 | 0.6 | 1.1 |
| Charpy Impact, kJ/m² | 10.6 | 1.8 | 3.0 | 9.1 |
| Gardner Impact, in-lb | 232 | 10 | 173 | 320 |
| Tensile Strength @ Yield, psi | 7,220 | 10,300 | 9,440 | 8,470 |
| Tensile Stress @ Break, psi | 7,140 | 7,380 | 6,980 | 6,560 |
| Elongation @ Yield % | 4.9 | 4.3 | 4.3 | 4.3 |
| Elongation @ Break % | 4 | 16 | 19 | 22 |
| Tensile Modulus, psi | 328,000 | 458,000 | 417,000 | 375,000 |
| Flex Modulus, psi | 345,000 | 492,000 | 449,000 | 406,000 |
| Flexural Strength at Yield, psi | 10,100 | 158,000 | 14,300 | 12,900 |
| Burn Rate (mm/min, UL94 HB) | 0 | 0 | 0 | 0 |

First Polymeric Component comprises CPVC, commercially available from Lubrizol Corporation.
Second Polymeric Component 1 comprises impact modifier, specifically acrylic impact modifier, commercially available from Rohm and Hass Chemicals LLC.
Second Polymeric Component 2 comprises SAN and impact modifier, specifically ASA, commercially available from BASF Corporation.
Third Polymeric Component comprises AMSAN, commercially available from BASF Corporation.

TABLE II

| | Composition Examples | | | |
|---|---|---|---|---|
| Components | Comparative 1 | Comparative 2 | Inventive 3 | Inventive 4 |
| First Polymeric Component | 100 | 50 | 50 | 40 |
| Second Polymeric Component 1 | — | — | — | — |
| Second Polymeric Component 2 | — | — | 20 | 20 |
| Third Polymeric Component | — | 50 | 30 | 40 |
| HDT, ° F. | 165.2 | 188.6 | 180.9 | 184.1 |
| Vicat, ° F. | 207.5 | 230.0 | 219.2 | 224.6 |
| CLTE (/° F. 10⁻⁶) | 34 | 32 | 35 | 35 |
| Notched Izod, ft-lb/in | 1.5 | 0.1 | 1.9 | 1.3 |
| Charpy Impact, kJ/m² | 10.6 | 1.8 | 11.5 | 9.8 |
| Gardner Impact, in-lb | 232 | 10 | 320 | 265 |
| Tensile Strength @ Yield, psi | 7,220 | 10,300 | 8,510 | 9,150 |
| Tensile Stress @ Break, psi | 7,140 | 7,380 | 6,500 | 6,790 |
| Elongation @ Yield % | 4.9 | 4.3 | 4.1 | 4 |
| Elongation @ Break % | 4 | 16 | 16 | 14 |
| Tensile Modulus, psi | 328,000 | 458,000 | 381,000 | 409,000 |
| Flex Modulus, psi | 345,000 | 492,000 | 414,000 | 438,000 |
| Flexural Strength at Yield, psi | 10,100 | 158,000 | 12,900 | 13,900 |
| Burn Rate (mm/min, UL94 HB) | 0 | 0 | 0 | 0 |

TABLE III

| | Composition Examples | | | |
|---|---|---|---|---|
| Components | Comparative 1 | Comparative 2 | Inventive 5 | Inventive 6 |
| First Polymeric Component | 100 | 50 | 50 | 30 |
| Second Polymeric Component 1 | — | — | — | — |
| Second Polymeric Component 2 | — | — | 10 | 10 |
| Third Polymeric Component | — | 50 | 40 | 60 |
| HDT, ° F. | 165.2 | 188.6 | 184.3 | 190.9 |
| Vicat, ° F. | 207.5 | 230.0 | 226.4 | 230.0 |
| CLTE (/° F. 10⁻⁶) | 34 | 32 | 33 | 32 |
| Notched Izod, ft-lb/in | 1.5 | 0.1 | 0.6 | 0.5 |
| Charpy Impact, kJ/m² | 10.6 | 1.8 | 3.7 | 2.8 |
| Gardner Impact, in-lb | 232 | 10 | 181 | 232 |
| Tensile Strength @ Yield, psi | 7,220 | 10,300 | 9,560 | 10,380 |
| Tensile Stress @ Break, psi | 7,140 | 7,380 | 7,090 | 7,570 |
| Elongation @ Yield % | 4.9 | 4.3 | 4.2 | 4.1 |
| Elongation @ Break % | 4 | 16 | 15 | 11 |
| Tensile Modulus, psi | 328,000 | 458,000 | 423,000 | 457,000 |
| Flex Modulus, psi | 345,000 | 492,000 | 454,000 | 499,000 |
| Flexural Strength at Yield, psi | 10,100 | 158,000 | 14,200 | 15,900 |
| Burn Rate (mm/min, UL94 HB) | 0 | 0 | 0 | 3 |

TABLE IV

| | Composition Examples | | |
|---|---|---|---|
| | Comparative | Comparative | |
| Components | 1 | 2 | Inventive 7 |
| First Polymeric Component | 100 | 50 | 35 |
| Second Polymeric | — | — | — |
| Component 1 | | | |
| Second Polymeric | — | — | 25 |
| Component 2 | | | |
| Third Polymeric Component | — | 50 | 40 |
| HDT, ° F. | 165.2 | 188.6 | 184.6 |
| Vicat, ° F. | 207.5 | 230.0 | 222.8 |
| CLTE (/° F. 10⁻⁶) | 34 | 32 | 35 |
| Notched Izod, ft-lb/in | 1.5 | 0.1 | 1.7 |
| Charpy Impact, kJ/m² | 10.6 | 1.8 | 11.2 |
| Gardner Impact, in-lb | 232 | 10 | 180 |
| Tensile Strength @ Yield, psi | 7,220 | 10,300 | 8,890 |
| Tensile Stress @ Break, psi | 7,140 | 7,380 | 6,680 |
| Elongation @ Yield % | 4.9 | 4.3 | 3.9 |
| Elongation @ Break % | 4 | 16 | 13 |
| Tensile Modulus, psi | 328,000 | 458,000 | 400,000 |
| Flex Modulus, psi | 345,000 | 492,000 | 431,000 |
| Flexural Strength at Yield, psi | 10,100 | 158,000 | 13,600 |
| Burn Rate (mm/min, | 0 | 0 | 0 |
| UL94 HB) | | | |

As illustrated in Tables I through IV above, all of the inventive examples have HDT's greater than 180° F., while Comparative 1 is considerably lower in HDT. In addition, all of the inventive examples have greater Notched Izod, Charpy Impact, and Gardner Impact strengths relative to Comparative 2. Many of the inventive examples have improved Vicat temperatures relative to the comparative examples, which provides for improved heat resistance relative to the comparative examples. Further, all of the inventive examples have Tensile Modulus and Flex Modulus greater than Comparative 1, which provides for improved warp resistance relative to Comparative 1. Other benefits of the inventive examples relative to the comparative examples can be appreciated with further reference to the tables above.

A comparative composite article example is prepared, specifically Comparative 3. Comparative 3 is 100% of the first polymeric component, i.e., is equivalent to Comparative 1, which is compounded via extrusion and extruded into a sheet having a thickness of 40 mils. An inventive composite article is also prepared, specifically Inventive 8. Inventive 8 comprises a blend of the first, second (number 2), and third polymeric components (and is equivalent to Inventive 3), which is compounded via extrusion and extruded into a sheet having a thickness of 40 mils. The sheets serve as the substrate layer of the composite article. Gardner Impact testing, according to ASTM D 4226, is performed on Comparative 3 and Inventive 8 prior to application of the capstock layer to the substrate layer. The amount and type of each component used to form the substrates are indicated in Tables V below with all values in parts by weight based on 100 parts by weight of the substrate layer unless otherwise indicated. The symbol “-” indicates that the component is absent from the formulation.

TABLE V

Composite Article Examples

| Components | Comparative 3 | Inventive 8 |
|---|---|---|
| First Polymeric Component | 100 | 50 |
| Second Polymeric | — | — |
| Component 1 | | |
| Second Polymeric | — | 20 |
| Component 2 | | |
| Third Polymeric Component | — | 30 |
| Gardner Impact, in-lb | 68 | 81 |

As illustrated in Table V above, Inventive 8 has increased Gardner Impact strength relative to Comparative 3. As such, the composite article can be used for a variety of applications as described and exemplified above. It is to be appreciated that other physical properties of Comparative 3 can be appreciated by reference to Comparative 1 in Tables I through IV above, while other physical properties of Inventive 8 can be appreciated by reference to Comparative 3 in Table I above.

The present invention has been described herein in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A composition comprising:
a first polymeric component comprising chlorinated polyvinyl chloride (CPVC);
a second polymeric component comprising at least one of (i) a mixture of styrene acrylonitrile (SAN) and an impact modifier, and (ii) a reaction product of said mixture; and
a third polymeric component comprising alpha-methylstyrene acrylonitrile (AMSAN);
wherein said second and third polymeric components are present in a combined amount of at least about 7 parts by weight based on 100 parts by weight of said composition and said composition has a heat distortion temperature greater than about 180° F. according to ASTM D 648.

2. A composition as set forth in claim 1 wherein said second and third polymeric components are present in a combined amount of at least about 10 parts by weight based on 100 parts by weight of said composition.

3. A composition as set forth in claim 2 wherein said second and third polymeric components are present in a combined amount of at least about 15 parts by weight based on 100 parts by weight of said composition.

4. A composition as set forth in claim 1 wherein said reaction product of said mixture comprises at least one of acrylonitrile styrene acrylate (ASA) and acrylonitrile butadiene styrene (ABS).

5. A composition as set forth in claim 1 wherein said impact modifier is selected from the group of acrylate rubbers, butyl-acrylate rubbers, ethylene-propylene-diene (EPDM) rubbers, methacrylate butadiene styrenes (MBS), chlorinated polyethylenes, and combinations thereof.

6. A composition as set forth in claim 1 having a heat distortion temperature greater than about 190° F. according to ASTM D 648.

7. A composition as set forth in claim 6 having a heat distortion temperature greater than about 200° F. according to ASTM D 648.

8. A composition as set forth in claim 1 wherein said first polymeric component is present in an amount of from about 30 to about 93, said second polymeric component is present in an amount of from about 2 to about 30, and said third polymeric component is present in an amount of from about 5 to about 45, parts by weight, all based on 100 parts by weight of said composition.

9. A composition as set forth in claim 1 further comprising a colorant component and having an L* value less than about 60.

10. A composition as set forth in claim 1 further comprising an additive component selected from the group of colorants, plasticizers, lubricants, UV stabilizers, thermal stabilizers, antioxidants, antistatic agents, flame retardants, fillers, fibers, processing aids, and combinations thereof.

11. A composite article comprising:
a capstock layer comprising a weatherable thermoplastic; and
a substrate layer comprising;
a first polymeric component comprising chlorinated polyvinyl chloride (CPVC),
a second polymeric component comprising at least one of (i) a mixture of styrene acrylonitrile (SAN) and an impact modifier, and (ii) a reaction product of said mixture; and
a third polymeric component comprising alpha-methylstyrene acrylonitrile (AMSAN),
wherein said second and third polymeric components are present in a combined amount of at least about 7 parts by weight based on 100 parts by weight of said substrate layer and said substrate layer has a heat distortion temperature greater than about 180° F. according to ASTM D 648.

12. A composite article as set forth in claim 11 wherein said second and third polymeric components are present in a combined amount of at least about 10 parts by weight based on 100 parts by weight of said substrate layer.

13. A composite article as set forth in claim 12 wherein said second and third polymeric components are present in a combined amount of at least about 15 parts by weight based on 100 parts by weight of said substrate layer.

14. A composite article as set forth in claim 11 wherein said weatherable thermoplastic comprises at least one of an acrylic polymer, a fluoropolymer, an acrylonitrile styrene acrylate (ASA), a polyvinyl chloride (PVC), a polyvinylidene fluoride (PVDF), poly(acrylonitrile ethylene styrene) (AES), and an aliphatic thermoplastic polyurethane (TPU).

15. A composite article as set forth in claim 11 wherein said reaction product of said mixture comprises at least one of acrylonitrile styrene acrylate (ASA) and acrylonitrile butadiene styrene (ABS).

16. A composite article as set forth in claim 11 wherein said impact modifier is selected from the group of acrylate rubbers, butyl-acrylate rubbers, ethylene-propylene-diene (EPDM) rubbers, methacrylate butadiene styrenes (MBS), chlorinated polyethylenes, and combinations thereof.

17. A composite article as set forth in claim 11 wherein at least one of said layers further comprises a colorant component.

18. A composite article as set forth in claim 17 having an L* value less than about 60.

19. A composite article as set forth in claim 18 having an L* value less than about 50.

20. A composite article as set forth in claim 19 having an L* value less than about 40.

21. A composite article as set forth in claim 11 wherein said first polymeric component is present in an amount of from about 30 to about 93, said second polymeric component is present in an amount of from about 2 to about 30, and said third polymeric component is present in an amount of from about 5 to about 45, parts by weight, all based on 100 parts by weight of said substrate layer.

22. A composite article as set forth in claim 11 wherein said capstock layer is bonded to said substrate layer.

23. A composite article as set forth in claim 22 wherein said layers have a combined thickness of at least about 22 mils.

24. A composite article as set forth in claim 23 wherein said capstock layer has a thickness of at least about 2 mils and said substrate layer has a thickness of at least about 20 mils.

25. A composite article as set forth in claim 11 wherein at least one of said layers further comprises an additive component selected from the group of colorants, plasticizers, lubricants, UV stabilizers, thermal stabilizers, antioxidants, antistatic agents, flame retardants, fillers, fibers, processing aids, and combinations thereof.
